(19) United States
(12) Patent Application Publication
(10) Pub. No.: US 2023/0323545 A1
(43) Pub. Date: Oct. 12, 2023

(54) ELECTROLYTIC CELLS WITH FLOW DIVERTERS, SYSTEMS CONTAINING THE ELECTROLYTIC CELLS, AND METHODS OF USING THE SAME

(71) Applicant: UGSI Solutions, Inc., Milpitas, CA (US)

(72) Inventors: Mark Kushman, Sunnyvale, CA (US); Billie Fritz, Fremont, CA (US); Chris Levash, San Rafael, CA (US)

(21) Appl. No.: 18/131,691

(22) Filed: Apr. 6, 2023

Related U.S. Application Data
(60) Provisional application No. 63/328,477, filed on Apr. 7, 2022.

(51) Int. Cl. C25B 9/15; C25B 11/034; C25B 1/04; C25B 1/26; C25B 15/08

(52) U.S. Cl. CPC C25B 9/15; C25B 11/034; C25B 1/04; C25B 1/26; C25B 15/083

(57) ABSTRACT

An electrolytic cell includes an inlet for receiving fluids into a first side of the electrolytic cell, an outlet opposite the inlet at a second side of the electrolytic cell where fluids exit the electrolytic cell, a cell body positioned between the inlet and the outlet having a plurality of bipolar electrode plates spaced apart, a first space formed between the inlet and the plurality of bipolar electrode plates, and a first flow diverter positioned within the first space. The first flow diverter includes a plurality of channels that adjust a flow of fluids flowing into the cell body from the inlet. A system using the electrolytic cells and methods of using the system are also included.

### CROSS-REFERENCE TO RELATED APPLICATIONS

This application claims the benefit of U.S. Provisional Patent Application No. 63/328,477 filed Apr. 7, 2022, incorporated herein by reference in its entirety.

### BACKGROUND

### Technical Field

The present disclosure is generally directed to electrolytic cells with flow diverters, systems containing the electrolytic cells, and methods of using the systems.

### Technical Description

Water utilities add disinfectants to water systems to prevent contamination from germs and bacteria. While chlorine is the most common secondary disinfectant, many water utilities are turning to chloramines, such as sodium hypochlorite, as the main secondary disinfectant. These hypochlorites are typically prepared on site to avoid issues associated with transportation and storage. For instance, sodium hypochlorite is commonly prepared by liberating hydrogen from a base solution on site using electrolytic cells.

While various electrolytic cell systems have been developed to improve the production of hypochlorites, these systems have various drawbacks. For example, electrolytic cell systems have been known to have poor distribution of reagents into the electrolytic plates and exhibit electrical fringe effects on the reactor/bi-polar plate edges. Thus, it is desirable to provide electrolytic cells that address the drawbacks know with current electrolytic cells.

### SUMMARY

In non-limiting embodiments or aspects, provided is an electrolytic cell that includes: an inlet for receiving fluids into a first side of the electrolytic cell; an outlet opposite the inlet at a second side of the electrolytic cell where fluids exit the electrolytic cell; a cell body positioned between the inlet and the outlet, the cell body having a plurality of bipolar electrode plates spaced apart; a first space formed between the inlet and the plurality of bipolar electrode plates; and a first flow diverter positioned within the first space, the first flow diverter having a plurality of channels that adjusts a flow of fluids flowing into the cell body from the inlet.

In some non-limiting embodiments or aspects, the first flow diverter includes a top surface, a bottom surface, and a body portion positioned between the top surface and bottom surface. The plurality of channels are formed through the top surface, body, and bottom surface of the first flow diverter. Each channel can also extend between the sides of the first flow diverter.

In some non-limiting embodiments or aspects, the sides of the first flow diverter extend below the body and include grips that extend under a portion of the bottom surface of the first flow diverter. The first flow diverter further comprises an additional support member that extends the bottom surface of the first flow diverter which is spaced apart from the grips of the sides of the first flow diverter.

In some non-limiting embodiments or aspects, the top surface of the first flow diverter faces the plurality of bipolar electrode plates when positioned in the first space. In some non-limiting embodiments or aspects, the top surface of the first flow diverter abuts the plurality of bipolar electrode plates when positioned in the first space. In some non-limiting embodiments or aspects, the top surface of the first flow diverter is spaced apart from the plurality of bipolar electrode plates when positioned in the first space.

In some non-limiting embodiments or aspects, the electrolytic cell further includes a second space formed between the outlet and the plurality of bipolar electrode plates, and a second flow diverter is positioned within the second space. The second flow diverter includes a plurality of channels that adjust a flow of fluids flowing out of the cell body through the outlet. In some non-limiting embodiments or aspects, the second flow diverter is the same as the first flow diverter. In some non-limiting embodiments or aspects, the second flow diverter can be different than the first flow diverter.

In some non-limiting embodiments or aspects, the first flow diverter is formed from two connecting components comprising a flow diverting section and a spacer plate. The flow diverting section engages and connects to the spacer plate.

In some non-limiting embodiments or aspects, provided is a system for treating water. The system includes a plurality of electrolytic cells in fluid communication with each other, in which at least one of the electrolytic cells includes any one of the previously described electrolytic cells having the flow diverter. The system further includes a vessel or container comprising a base solution in fluid communication with at least one of the electrolytic cells.

In some non-limiting embodiments or aspects, each of the electrolytic cells includes the previously described inlet electrolytic cell with the flow diverter. Further, the hydrogen is liberated from the base solution to form sodium hypochlorite after the base solution is passed through the electrolytic cells.

In some non-limiting embodiments, the electrolytic cells further include a second space formed between the outlet and the plurality of bipolar electrode plates, and a second flow diverter is positioned within the second space, as previously described. The second flow diverter includes a plurality of channels that adjust a flow of fluids flowing out of the cell body through the outlet.

In non-limiting embodiments or aspects, provided is a method of liberating hydrogen from a base solution. The method includes: (a) directing a base solution into an electrolytic cell, the electrolytic cell including any one of the electrolytic cells previously described; (b) diverting flow of the base solution with the first flow diverter; (c) passing the base solution through the plurality of bipolar electrode plates; (d) supplying current to plurality of bipolar electrode plates, and charging the bipolar electrode plates as the base solution passes through the bipolar electrode plates; and (e) liberating hydrogen from the base solution.

In some non-limiting embodiments or aspects, the method further includes passing the base solution treated by the charged bipolar electrode plates through a second diverter positioned within a second space of the electrolytic cell, in which the second flow diverter includes a plurality of channels that adjust a flow of the treated base solution out of the cell body through the outlet.

Further non-limiting embodiments or aspects are set forth in the following numbered clauses:

Clause 1: An electrolytic cell comprising: an inlet for receiving fluids into a first side of the electrolytic cell; an outlet opposite the inlet at a second side of the electrolytic cell where fluids exit the electrolytic cell; a cell body positioned between the inlet and the outlet, the cell body comprising a plurality of bipolar electrode plates spaced apart; a first space formed between the inlet and the plurality of bipolar electrode plates; and a first flow diverter positioned within the first space, the first flow diverter comprising a plurality of channels that adjusts a flow of fluids flowing into the cell body from the inlet.

Clause 2: The electrolytic cell of clause 1, wherein the first flow diverter comprises a top surface, a bottom surface, and a body portion positioned between the top surface and bottom surface, and wherein the plurality of channels are formed through the top surface, body, and bottom surface of the first flow diverter.

Clause 3: The electrolytic cell of clauses 1 or 2, wherein each channel extends between the sides of the first flow diverter.

Clause 4: The electrolytic cell of any of clauses 1-3, wherein the sides of the first flow diverter extend below the body and comprise grips that extend under a portion of the bottom surface of the first flow diverter.

Clause 5: The electrolytic cell of any of clauses 1-4, wherein the first flow diverter further comprises an additional support member that extends the bottom surface of the first flow diverter which is spaced apart from the grips of the sides of the first flow diverter.

Clause 6: The electrolytic cell of any of clauses 1-5, wherein the top surface of the first flow diverter faces the plurality of bipolar electrode plates when positioned in the first space.

Clause 7: The electrolytic cell of any of clauses 1-6, wherein the top surface of the first flow diverter abuts the plurality of bipolar electrode plates when positioned in the first space.

Clause 8: The electrolytic cell of any of clauses 1-6, wherein the top surface of the first flow diverter is spaced apart from the plurality of bipolar electrode plates when positioned in the first space.

Clause 9: The electrolytic cell of any of clauses 1-8, further comprising a second space formed between the outlet and the plurality of bipolar electrode plates and a second flow diverter positioned within the second space, wherein the second flow diverter comprises a plurality of channels that adjust a flow of fluids flowing out of the cell body through the outlet.

Clause 10: The electrolytic cell of any of clauses 1-9, wherein the second flow diverter is the same as the first flow diverter.

Clause 11: The electrolytic cell of any of clauses 1-10, wherein the first flow diverter is formed from two connecting components comprising a flow diverting section and a spacer plate, and wherein the flow diverting section engages and connects to the spacer plate.

Clause 12: A system for treating water comprising: (a) a plurality of electrolytic cells in fluid communication with each other, wherein at least one of the electrolytic cells comprises any of the electrolytic cells of any of clauses 1-11; and (b) a vessel or container comprising a base solution in fluid communication with at least one of the electrolytic cells.

Clause 13: The system of clause 12, wherein each of the electrolytic cells comprises any of the electrolytic cells of any of clauses 1-11.

Clause 14: The system of clauses 12 or 13, wherein hydrogen is liberated from the base solution to form sodium hypochlorite after the base solution is passed through the electrolytic cells.

Clause 15: A method of liberating hydrogen from a base solution comprising: (a) directing a base solution into an electrolytic cell, the electrolytic cell comprising any of the electrolytic cells of any of clauses 1-11; (b) diverting flow of the base solution with the first flow diverter; (c) passing the base solution through the plurality of bipolar electrode plates; (d) supplying current to the plurality of bipolar electrode plates and charging the bipolar electrode plates as the base solution passes through the bipolar electrode plates; and (e) liberating hydrogen from the base solution.

Clause 16: The method of clause 15, further comprising: passing the base solution treated by the charged bipolar electrode plates through a second diverter positioned within a second space of the electrolytic cell, wherein the second flow diverter comprises a plurality of channels that adjust a flow of the treated base solution out of the cell body through the outlet.

### BRIEF DESCRIPTION OF THE DRAWINGS

FIG. 1 illustrates a perspective cutaway view of non-limiting embodiments or aspects of an electrolytic cell having flow diverters according to the principles of the present disclosure;

FIG. 2 illustrates a perspective view of non-limiting embodiments or aspects of a flow diverter according to the principles of the present disclosure;

FIG. 3 is a top view of the flow diverter in FIG. 2;

FIG. 4 is a side view of the flow diverter in FIG. 2;

FIG. 5 illustrates non-limiting embodiments or aspects of the channel depth and dimensions of a flow diverter according to the principles of the present disclosure;

FIG. 6A illustrates a perspective cutaway view of non-limiting embodiment or aspect of a flow diverter formed from two connecting components according to the principles of the present disclosure;

FIG. 6B is a perspective view of FIG. 6A with the from two connecting components connected;

FIG. 7A illustrates a perspective cutaway view of another non-limiting embodiment or aspect of a flow diverter formed from two connecting components according to the principles of the present disclosure;

FIG. 7B is a perspective view of FIG. 7A with the from two connecting components connected;

FIG. 8A illustrates a perspective cutaway view of yet another non-limiting embodiment or aspect of a flow diverter formed from two connecting components according to the principles of the present disclosure;

FIG. 8B is a perspective view of FIG. 8A with the from two connecting components connected;

FIG. 9 is a perspective view of non-limiting embodiments or aspects of a system for treating water according to the present disclosure; and

FIG. 10 is a perspective view of non-limiting embodiments or aspects of the array of electrolytic cells and the connection system illustrated in FIG. 9.

### DETAILED DESCRIPTION

For purposes of the following detailed description, it is to be understood that the disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Further, the terms “upper”, “lower”, “right”, “left”, “vertical”, “horizontal”, “top”, “bottom”, “lateral”, “longitudinal”, and derivatives thereof shall relate to the disclosure as it is oriented in the drawing figures. However, it is to be understood that the disclosure may assume alternative variations and step sequences, except where expressly specified to the contrary. It is also to be understood that the specific devices and processes illustrated in the attached drawings, and described in the specification, are simply exemplary embodiments of the disclosure. Hence, specific dimensions and other physical characteristics related to the embodiments disclosed herein are not to be considered as limiting.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

In non-limiting embodiments or aspects, the present disclosure is directed to an electrolytic cell 10 having a flow diverter 100. It is appreciated that various types of electrolytic cells 10 can be modified to include the flow diverter 100 based on the disclosure described herein.

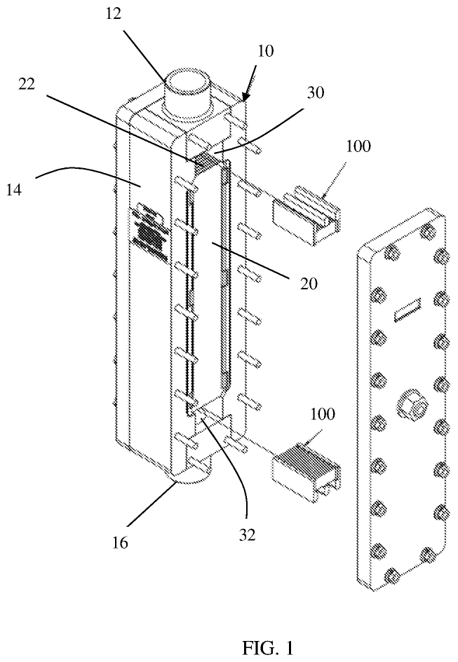

Referring to FIG. 1, in some non-limiting embodiments or aspects, the electrolytic cell 10 includes an inlet 12, a cell body 14, and an outlet 16. The inlet 12 of the electrolytic cell 10 allows materials and, in particular, a liquid solution to enter the cell body 14. After entering the cell body 14, the liquid solution passes through a plurality of bipolar electrode plates 20 that are spaced apart from each other. The spaces between the bipolar electrode plates 20 form compartments 22 through which a liquid, such as a base solution, passes. As the liquid solution passes through the electrolytic cell 10, a current is applied by the plates 20 such that hydrogen is liberated from the solution. The treated liquid solution then exits the cell body 14 through the outlet 16.

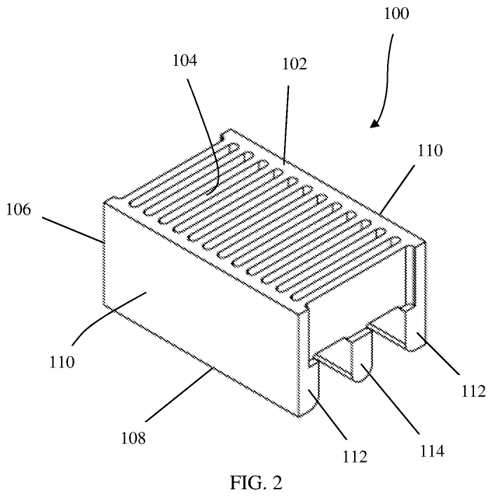

Other features of the electrolytic cell 10 shown in FIG. 1 are described in U.S. Pat. No. 10,975,479, which is incorporated herein in its entirety. For instance, FIGS. 1 and 2, and column 6 line 28 though column 10 line 20 of U.S. Pat. No. 10,975,479 describe various aspects of the electrolytic cell 10 that can be used as the electrolytic cell 10 of the present disclosure.

As further shown in FIG. 1, and in non-limiting embodiments or aspects, the electrolytic cell 10 includes at least a first space 30 that is shaped and sized to receive a flow diverter 100. The first space 30 is positioned between the inlet 12 and the plurality of bipolar electrode plates 20. In non-limiting embodiments or aspects, as shown in FIG. 1, the electrolytic cell 10 can further include a second space 32 that is shaped and sized to receive a second flow diverter 100. As further shown in FIG. 1, the second space 32 is positioned between the outlet 16 and the plurality of bipolar electrode plates 20.

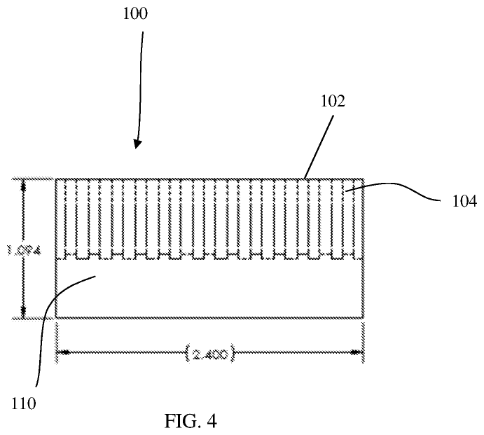

Referring to FIGS. 2-4, the flow diverter 100 can include a top surface 102 having a plurality of channels 104 that extend through the top surface 102, body 106, and bottom surface 108 of the flow diverter 100. The channels 104 can also extend between the sides 110 of the flow diverter 100. It is appreciated that the channels 104 allow fluids to flow through the flow diverter 100 according to the pathways formed from the channels 104.

In non-limiting embodiments or aspects, and referring to FIG. 2, the sides 110 of the flow diverter 100 can extend below the body 106 and include grips 112 that extend under the bottom surface 108 of the flow diverter 100. The grips 112 extend under a portion of the surface 108 such that the grips 112 do not interfere with the desired flow of fluids through the channels 104. The flow diverter 100 can also include an additional support member 114 that extends under a different area of the bottom surface 108. For instance, as shown in FIGS. 1-3, the additional support member 114 can be positioned between the sides 110 of the flow diverter 100 and extend along the entire length of the bottom surface 100. The additional support member 114 is also spaced apart from the grips 112 of the sides 110 to allow fluids to flow as desired.

The previously described grips 112 and additional support member 114 support and secure the body 106 of the flow diverter 100. The grips 112 and additional support member 114 also help to align and secure the flow diverter 100 within the spaces 30, 32 of the flow diverter 100.

As previously described, the flow diverter 100 is inserted into the first and second spaces 30, 32 of the flow diverter 100. As shown in FIG. 1, the flow diverters 100 are inserted into the spaces 30, 32 such that the top surface 102 of the flow diverters 100 face the plurality of plates 20. As such, the grips 112 and additional support member 114 of the flow diverter 100 in the first space 30 face the inlet 12, and the grips 112 and additional support member 114 of the flow diverter 100 in the second space 32 face the outlet 16.

In non-limiting embodiments or aspects, the flow diverter 100 is inserted into the first and second spaces 30, 32 of the flow diverter 100 such that the top surface 102 contacts or abuts the ends of the plates 20. In some non-limiting embodiments or aspects, the top surface 102 of the flow diverter 100 is spaced apart from the ends of the plates 20.

The flow diverter 100 can also have various shapes and sizes provided that the flow diverter 100 fits into the desired spaces 30, 32. The flow diverters 100 for the first and second spaces 30, 32 can have the same size and shape, or the flow diverters 100 can have a different size and shape based on the size and shape of each space 30, 32. In some non-limiting embodiments, the flow diverter 100 has a rectangular shape, and the flow diverters 100 for the first and second spaces 30, 32 have the same size and shape.

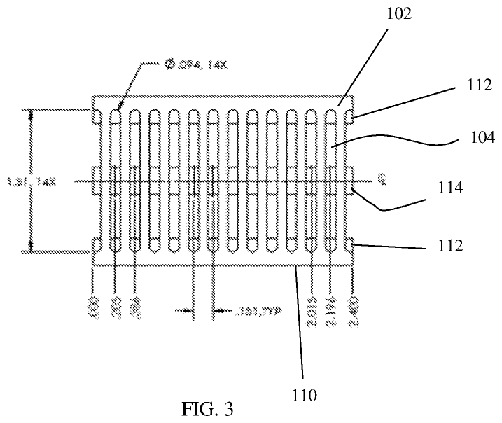

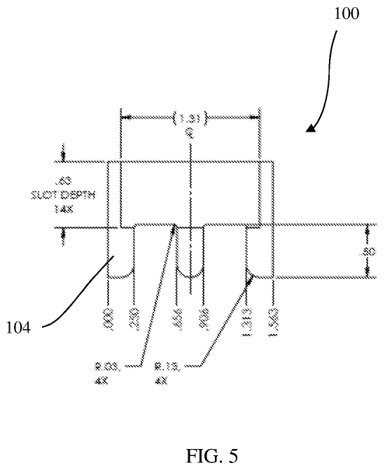

The channels 104 of the flow diverter 100 can also have various sizes (e.g. lengths, widths, and depths). It is appreciated that the channels 104 are sized to control the fluids through the channels 104 and provide a desired flow rate. FIGS. 3-5 illustrate non-limiting embodiments or aspects of dimensions of the different features of the flow diverter 100.

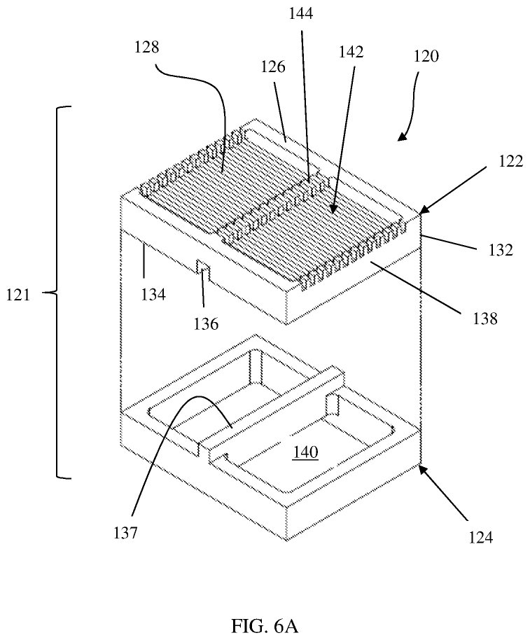

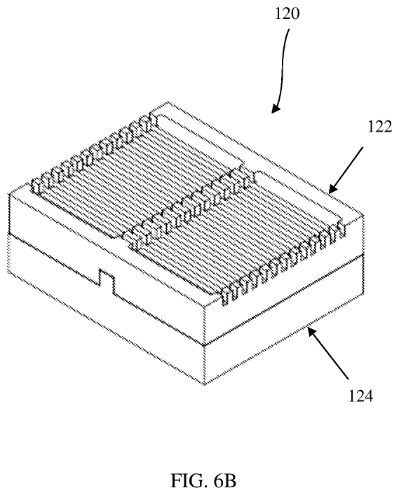

Referring to FIGS. 6A and 6B, in some non-limiting embodiments or aspects, the present disclosure can also include a flow diverter 120 formed from two components 121. The two connecting components 121 include a flow diverting section 122 and a spacer plate 124.

As shown in FIGS. 6A and 6B, the flow diverting section 122 includes a top surface 126 having a plurality of channels 128 that extend through the top surface 126, body 132, and bottom surface 134 of the flow diverting section 122. The channels 128 can also extend between the sides 138 of the flow diverting section 122. It is appreciated that the channels 128 allow fluids to flow through the flow diverting section 122 according to the pathways formed from the channels 128.

As further shown in FIGS. 6A and 6B, the spacer plate 124 engages and connects to the flow diverting section 122. For instance, referring to FIGS. 6A and 6B, the spacer plate 124 can engage and connect to the bottom surface 134 of the flow diverting section 122. It will be appreciated that various arrangements can be used to engage and connect the flow diverter 122 to the spacer plate 124. For example, referring to FIGS. 6A and 6B, the bottom surface of the flow diverting section 122 can include at least one groove 136 and the spacer plate 124 can include at least one protrusion 137 that is shaped and sized to be inserted into the groove 136 to secure the flow diverting section 122 to the spacer plate 124.

The flow diverting section 122 and spacer plate 124 can also have various shapes and sizes to fit into the desired spaces 30, 32 of an electrolytic cell 10. As shown in FIGS. 6A and 6B, the flow diverting section 122 and the spacer plate 124 can have the same dimensions (e.g., width and length, and optionally height). The spacer plate 124 also includes at least one slot 140 that is positioned below or above the channels 128 of the flow diverting section 122 where fluid entering or leaving the flow diverting section 122 flows.

The flow diverter 122 can also include 2 or more sectioned areas 142 comprising the channels 128. FIGS. 6A and 6B illustrate a flow diverter 122 with two sectioned areas 142 comprising the channels 128. Each sectioned area 142 is separated by a protruding section 144 on the top surface 126 that is positioned above the groove 134. It is appreciated that the spacer plate 124 includes a matching amount of slots 140 that correspond with each sectioned area 142.

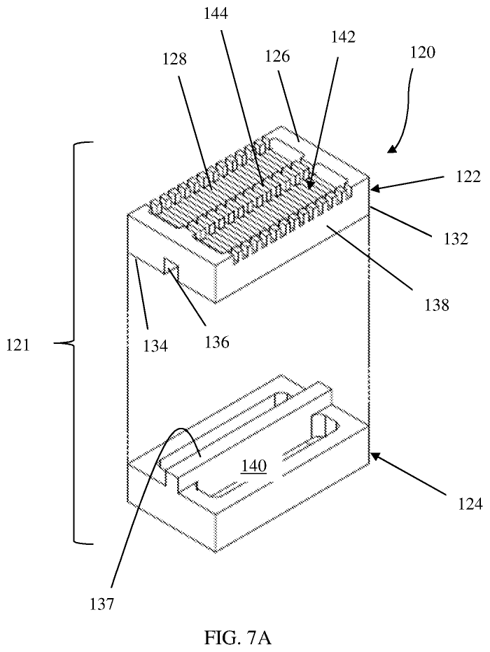

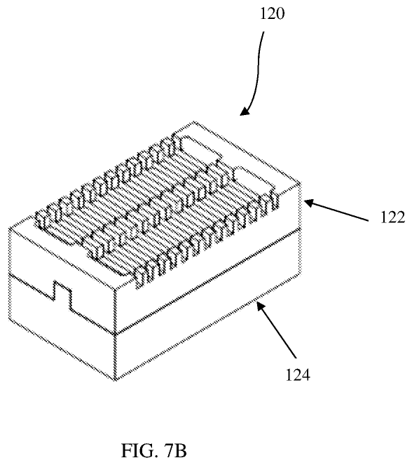

As previously described, flow diverting section 122 and spacer plate 124 can also have various shapes and sizes to fit into the desired spaces 30, 32 of an electrolytic cell 10. FIGS. 7A and 7B illustrate a narrower shaped flow diverting section 122 and corresponding spacer plate 124.

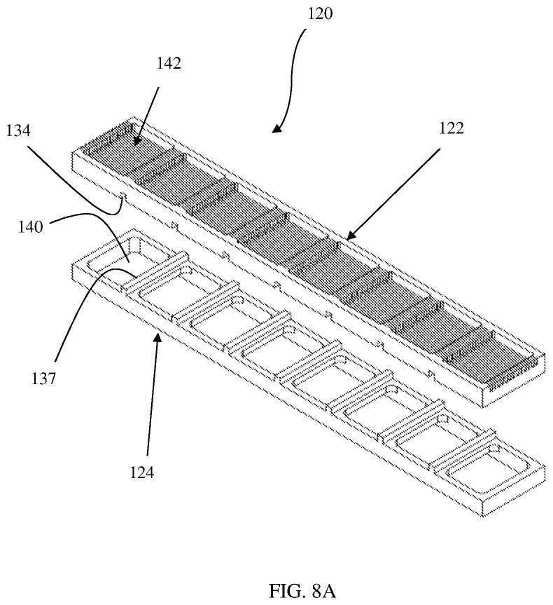

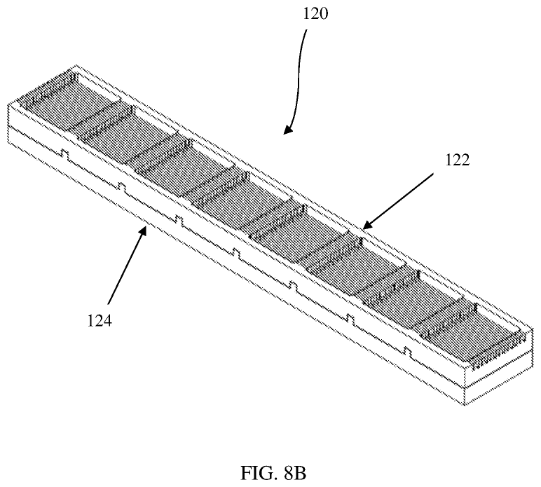

FIGS. 8A and 8B illustrate a larger flow diverter 120 formed from two components 121 that includes a flow diverting section 122 having 8 compartments 142 and multiple grooves 134, and a spacer plate 124 having 8 corresponding slots 140 and multiple corresponding protrusions 137.

The flow diverter 120 formed from the two components 121 can be installed by first installing the flow diverting section 122 onto the cell plates 20. The spacer plate 124 can then be slid between the flow diverting section 122 and the inlet/outlets 12 of the electrolytic cell 10. The spacer plate 124 is engaged and connected to the flow diverting section 122. In certain non-limiting embodiments or aspects, a larger flow diverter 120, such as the one shown in FIGS. 8A and 8B, is used and extends the full width of the electrolytic cell 10.

The structure of the flow diverter 100, 120 according to the principles of the present disclosure optimizes flow paths to channel flow from one flow shape to another as the fluid of the liquid changes from the pipe attached to the inlet 12 to a different shape of the electrolytic cell 10, such as a rectangular shape. For instance, the channels 104 of the flow diverter 100 can be modeled off the pipe flow profile and the spacing of the electrolytic plates 20 to optimize the flow paths. As such, the flow diverter 100, 120 can alter the flow from a pipe leading into the inlet 12 directly to a different cross-sectional array, such as a rectangular cross-sectional array, to better distribute reagents into gaps of the plates 20. This design also alters the back and static pressures of the fluid flow which slows flow allowing better contact time with the plates 20 and optimizes the flow rate through the cell 10.

In addition to flow path alteration and flow rate optimization, the flow diverter 100 can provide electrical insulation and eddy disruption. For example, the flow diverter 100, 120 can electrically insulate the edges of the reactor/bi-polar plates 20 which removes these fringe effects altogether. This electrical insulation also prevents uneven electrical wear on the plates 20 to increase the lifespan of the plates 20 before breakdown. In addition, by occupying the space 30, 32 around the plates 20, the flow diverter 100, 120 disrupts any eddies from forming around the plates 20 and trapping reagents and any product in them.

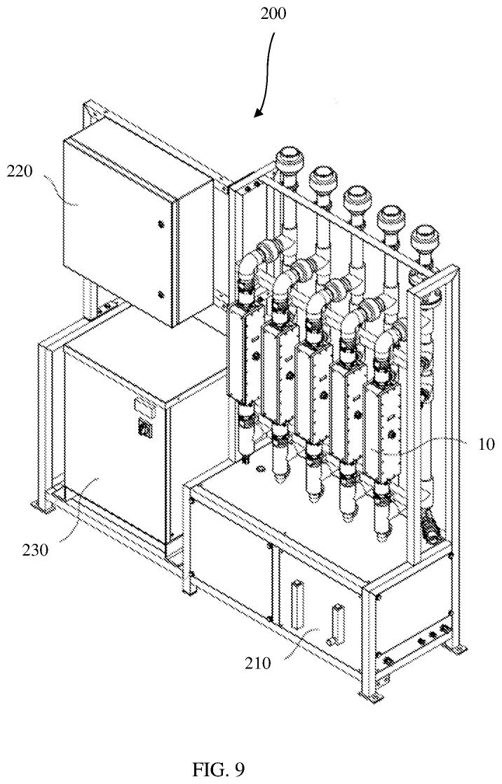

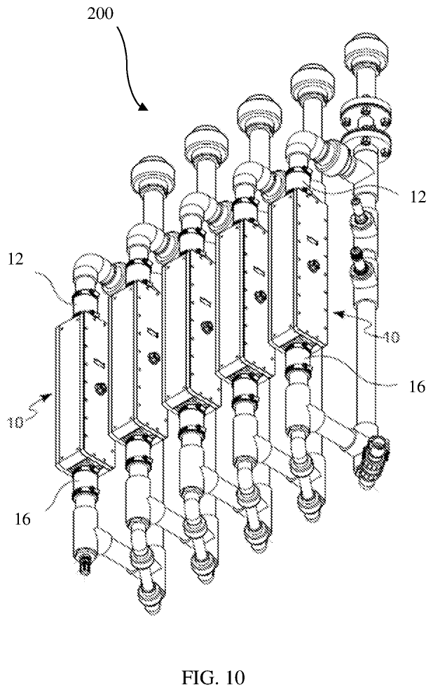

Referring to FIG. 9, the present disclosure also relates to a water treatment system 200 that includes a base solution that can be stored in one or more vessels or containers 210 which is in fluid communication with one or more of the previously described electrolytic cells 10. For example, and as shown in the non-limiting embodiments or aspects of FIGS. 9 and 10, the water treatment system 200 can include an array or plurality of electrolytic cells 10 that are in fluid communication with each other, which is in fluid communication with a base solution contained in a vessel or container 210. The system 200 can also include various other components such as, for example, an electrical device 230 that transfers electrical energy to electrolytic cells 10. A non-limiting example of such an electrical device 130 is an electrical transformer.

A non-limiting example of a suitable water treatment system which can be modified to include the electrolytic cells 10 of the present disclosure is described in U.S. Pat. No. 7,897,022 at least in column 7, line 6 to column 11, line 41 and the corresponding figures, which is incorporated by reference herein.

In some non-limiting embodiments or aspects, the base solution comprises a salt dissolved in water to form a concentrated brine solution. The water may be processed with a water softener prior to treatment. The brine or base solution can be fed into the electrolytic cells 10 of the present disclosure. It is appreciated that the brine or base solution can be prepared and delivered into the electrolytic cells using various pumps, vessels, and transfers lines. Non-limiting examples of such devices that can be used with the system are described in U.S. Pat. No. 7,897,022 at least in column 7, line 6 to column 8, line 42 and the corresponding figures, which is incorporated by reference herein.

In accordance with the present disclosure, the previously described electrolytic cells 10 convert the brine or base solution into a sodium hypochlorite solution and hydrogen using electrical power. In particular, the diluted brine solution is fed into the inlet 12 of the cell 10 and passes through the electrolytic cell 10 so that hydrogen is liberated from the solution to form sodium hypochlorite.

In some non-limiting embodiments or aspects, the sodium hypochlorite and hydrogen produced by a first electrolytic cell 10 are both fed out of the cell outlet 16 and toward a junction. The junction is configured such that the density differentials between the sodium hypochlorite and the hydrogen passively separate into different dedicated bifurcated lines. The modified solution (containing a small percentage of sodium hypochlorite) is directed down the return line, while the hydrogen vents vertically out of a second line to output. The return line reaches a second junction, wherein a portion of the modified solution is cycled back through the electrolytic cell 10, and another portion of the modified solution is directed through a smaller feed tube to the inlet 12 of the second electrolytic cell 10 of the series. The process is repeated until the solution has passed through all of the electrolytic cells 10 and into an electrolytic cell 10 outlet line. After processing, the sodium hypochlorite can be transferred into a vessel or other containment means.

It is appreciated that the electrolytic cells 10 passively allow all produced hydrogen to be removed from each electrolytic cell 10 by the density differential created during the electrolytic process. In some non-limiting embodiments or aspects, the electrolytic cells 10 are vertically aligned hydraulically in series. The vertical orientation and configuration of the electrolytic cells 10 allows for the instantaneous passive removal of the hydrogen produced. The electrolytic cells 10 of the present disclosure are arranged to also provide a re-circulation of the solution, which provides for many benefits including reduced scaling potential, lower resistance, lower heat gain, lower chlorate formation, and higher overall efficiencies.

In some non-limiting embodiments or aspects, the system is automatically operated by a controller 220. It is appreciated that the controller 220 may include one or more microprocessors, CPUs, and/or other computing devices. One or more computer-readable storage mediums can be in operable communication with the controller. The computer-readable storage mediums can contain programming instructions that, when executed, cause the controller to perform multiple tasks.

The system of the present disclosure can include other components and processing parameters, as well as delivering and dosing systems/devices. Non-limiting examples of such components and processes are described in U.S. Pat. No. 7,897,022 at least in column 7, line 6 to column 15, line 67 and the corresponding figures, which is incorporated by reference herein.

Whereas particular embodiments of this disclosure have been described above for purposes of illustration, it will be evident to those skilled in the art that numerous variations of the details of the present disclosure may be made without departing from the disclosure as defined in the appended claims.

What is claimed is:

1. An electrolytic cell comprising:
an inlet for receiving fluids into a first side of the electrolytic cell;
an outlet opposite the inlet at a second side of the electrolytic cell where fluids exit the electrolytic cell;
a cell body positioned between the inlet and the outlet, the cell body comprising a plurality of bipolar electrode plates spaced apart;
a first space formed between the inlet and the plurality of bipolar electrode plates; and
a first flow diverter positioned within the first space, the first flow diverter comprising a plurality of channels that adjust a flow of fluids flowing into the cell body from the inlet.

2. The electrolytic cell of claim 1, wherein the first flow diverter comprises a top surface, a bottom surface, and a body portion positioned between the top surface and the bottom surface, and wherein the plurality of channels are formed through the top surface, the body, and the bottom surface of the first flow diverter.

3. The electrolytic cell of claim 2, wherein each channel extends between sides of the first flow diverter.

4. The electrolytic cell of claim 3, wherein the sides of the first flow diverter extend below the body and comprise grips that extend under a portion of the bottom surface of the first flow diverter.

5. The electrolytic cell of claim 4, wherein the first flow diverter further comprises an additional support member that extends the bottom surface of the first flow diverter which is spaced apart from the grips of the sides of the first flow diverter.

6. The electrolytic cell of claim 1, wherein the top surface of the first flow diverter faces the plurality of bipolar electrode plates when positioned in the first space.

7. The electrolytic cell of claim 6, wherein the top surface of the first flow diverter abuts the plurality of bipolar electrode plates when positioned in the first space.

8. The electrolytic cell of claim 6, wherein the top surface of the first flow diverter is spaced apart from the plurality of bipolar electrode plates when positioned in the first space.

9. The electrolytic cell of claim 1, further comprising a second space formed between the outlet and the plurality of bipolar electrode plates, and a second flow diverter positioned within the second space, wherein the second flow diverter comprises a plurality of channels that adjust a flow of fluids flowing out of the cell body through the outlet.

10. The electrolytic cell of claim 1, wherein a second flow diverter is the same as the first flow diverter.

11. The electrolytic cell of claim 1, wherein the first flow diverter is formed from two connecting components comprising a flow diverting section and a spacer plate, and wherein the flow diverting section engages and connects to the spacer plate.

12. A system for treating water comprising:
a) a plurality of electrolytic cells in fluid communication with each other, at least one of the electrolytic cells comprising:
an inlet for receiving fluids into a first side of the electrolytic cell;
an outlet opposite the inlet at a second side of the electrolytic cell where fluids exit the electrolytic cell;
a cell body positioned between the inlet and the outlet, the cell body comprising a plurality of bipolar electrode plates spaced apart;
a first space formed between the inlet and the plurality of bipolar electrode plates; and
a first flow diverter positioned within the first space, the first flow diverter comprising a plurality of channels that adjusts a flow of fluids flowing into the cell body from the inlet; and
b) a vessel or container comprising a base solution in fluid communication with at least one of the electrolytic cells.

13. The system of claim 12, wherein each of the electrolytic cells comprises the inlet, the outlet, the cell body, the first space, and the first flow diverter positioned within the first space.

14. The system of claim 12, wherein hydrogen is liberated from the base solution to form sodium hypochlorite after the base solution is passed through the electrolytic cells.

15. The system of claim 12, wherein the first flow diverter comprises a top surface, a bottom surface, and a body portion positioned between the top surface and the bottom surface, wherein the plurality of channels are formed through the top surface, the body, and the bottom surface of the first flow diverter, and each channel extends between sides of the first flow diverter.

16. The system of claim 15, wherein the sides of the first flow diverter extend below the body and comprise grips that extend under a portion of the bottom surface of the first flow diverter.

17. The system of claim 16, wherein the first flow diverter further comprises an additional support member that extends the bottom surface of the first flow diverter which is spaced apart from the grips of the sides of the first flow diverter.

18. The system of claim 12, wherein the top surface of the first flow diverter faces the plurality of bipolar electrode plates when positioned in the first space.

19. The system of claim 12, further comprising a second space formed between the outlet and the plurality of bipolar electrode plates, and a second flow diverter positioned within the second space, wherein the second flow diverter comprises a plurality of channels that adjust a flow of fluids flowing out of the cell body through the outlet.

20. The system of claim 12, wherein the first flow diverter is formed from two connecting components comprising a flow diverting section and a spacer plate, and wherein the flow diverting section engages and connects to the spacer plate.

21. A method of liberating hydrogen from a base solution comprising:
a) directing a base solution into an electrolytic cell, the electrolytic cell comprising:
an inlet for receiving fluids into a first side of the electrolytic cell;
an outlet opposite the inlet at a second side of the electrolytic cell where fluids exit the electrolytic cell;
a cell body positioned between the inlet and the outlet, the cell body comprising a plurality of bipolar electrode plates spaced apart;
a first space formed between the inlet and the plurality of bipolar electrode plates; and
a first flow diverter positioned within the first space, the first flow diverter comprising a plurality of channels; and
b) diverting flow of the base solution with the first flow diverter;
c) passing the base solution through the plurality of bipolar electrode plates;
d) supplying a current to the plurality of bipolar electrode plates, and charging the bipolar electrode plates as the base solution passes through the bipolar electrode plates; and
e) liberating hydrogen from the base solution.

22. The method of claim 21, further comprising passing the base solution treated by the charged bipolar electrode plates through a second flow diverter positioned within a second space of the electrolytic cell, wherein the second flow diverter comprises a plurality of channels that adjusts a flow of the treated base solution out of the cell body through the outlet.
